(19) United States
(12) Patent Application Publication
(10) Pub. No.: US 2007/0247390 A1
(43) Pub. Date: Oct. 25, 2007

(54) Antenna and supporting structure thereof

(75) Inventors: Hung Yuan Lin, Taipei (TW); San Yi Kuo, Taipei (TW)

Correspondence Address: QUINTERO LAW OFFICE, PC, 2210 MAIN STREET, SUITE 200, SANTA MONICA, CA, 90405, US

(73) Assignee: WISTRON NEWEB CORP., TAIPEI HSIEN (TW)

(21) Appl. No.: 11/473,844

(22) Filed: Jun. 23, 2006

(30) Foreign Application Priority Data
Apr. 20, 2006 (TW) TW95114103

(51) Int. Cl. H01Q 1/12

(52) U.S. Cl. 343/892; 343/878

(57) ABSTRACT

An antenna comprises a support structure and a downconverter. The support structure comprises a dish, a supporting assembly, and a connecting element. The supporting assembly comprises a dish bracket unit and a supporting arm to connect to the dish bracket unit. The connecting element between the dish and the dish bracket unit is a medium for connecting the dish to the supporting assembly.

### BACKGROUND OF THE INVENTION

1. Field of the Invention

The invention relates to an antenna and a supporting structure thereof, and in particular to a supporting structure which supports various size dishes.

2. Description of the Related Art

An antenna set 10 receives data from a satellite. Referring to FIG. 1, the antenna set 10 comprises a dish 11, a supporting assembly 12 and downconcerter (not shown). The supporting assembly 12 comprises a connecting portion 121, a dish bracket unit 122 and a supporting arm 123. The connecting portion 121 is connected to the dish 11. Moreover, the connecting portion 121 is fixed on the dish 11 via a fixing element 14, thus, the supporting assembly 12 stably supports the dish 11.

Because the supporting assembly 12 must stably support the dish 11, the dish size is proportional to the dish bracket unit size. Dish size, however, are varied. When manufacturing a large type antenna set 10, the dish bracket unit size increases. When manufacturing a small type antenna set 10, the dish bracket unit size decreases. Note that the supporting assembly 12 is a single and unitary member. Redesigning supporting assembly 12 to stably support various sizes of dish 11 will increase cost.

### BRIEF SUMMARY OF INVENTION

A detailed description is given in the following embodiments with reference to the accompanying drawings. The invention provides a supporting structure of an antenna. The supporting structure comprises a supporting assembly and a connecting element. The supporting assembly comprises a dish bracket unit and a supporting arm for connecting to the dish bracket unit. The connecting element is connected between the dish and the dish bracket unit. When the dish size changes, the dish bracket unit does not change; but the connecting element changes. Because the unitary supporting assembly is more complex than the connecting element, keeping the supporting assembly does not increase cost.

The invention provides an antenna set. The antenna set comprises a dish, a supporting assembly, a connecting element and a downconverter. The downconverter is installed on the dish. The supporting assembly comprises a dish bracket unit and a supporting arm to connect to the dish bracket unit. The connecting element is installed between the dish and the dish bracket unit to connect therebetween.

### BRIEF DESCRIPTION OF DRAWINGS

The invention can be more fully understood by reading the subsequent detailed description and examples with references made to the accompanying drawings, wherein:

FIG. 1 is a schematic view of a conventional antenna set;

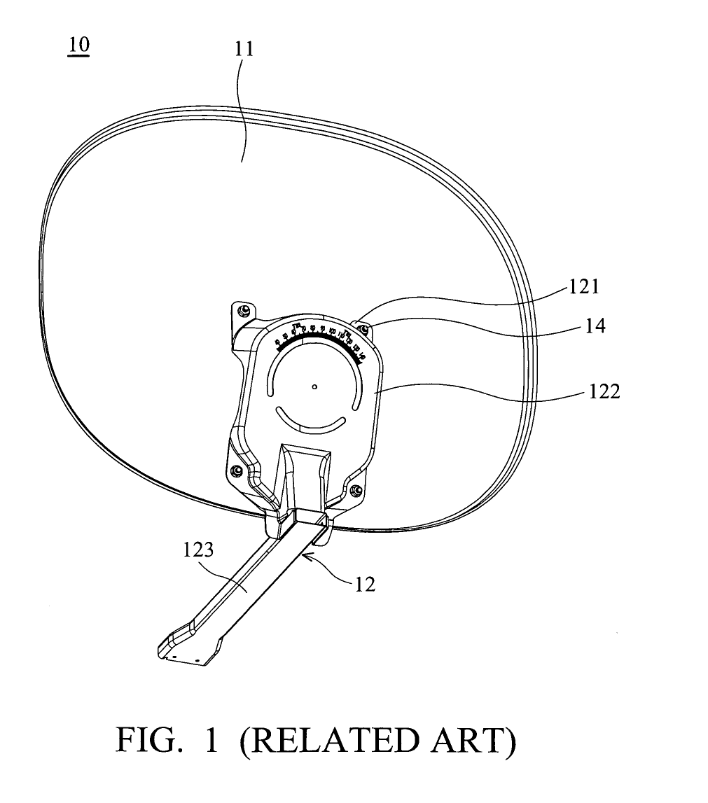

FIG. 2 is a schematic view of an antenna set of the invention;

FIG. 3 is an exploded view of an antenna set of the invention;

FIG. 4 is a reverse side of the connecting element and the supporting assembly in FIG. 3.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

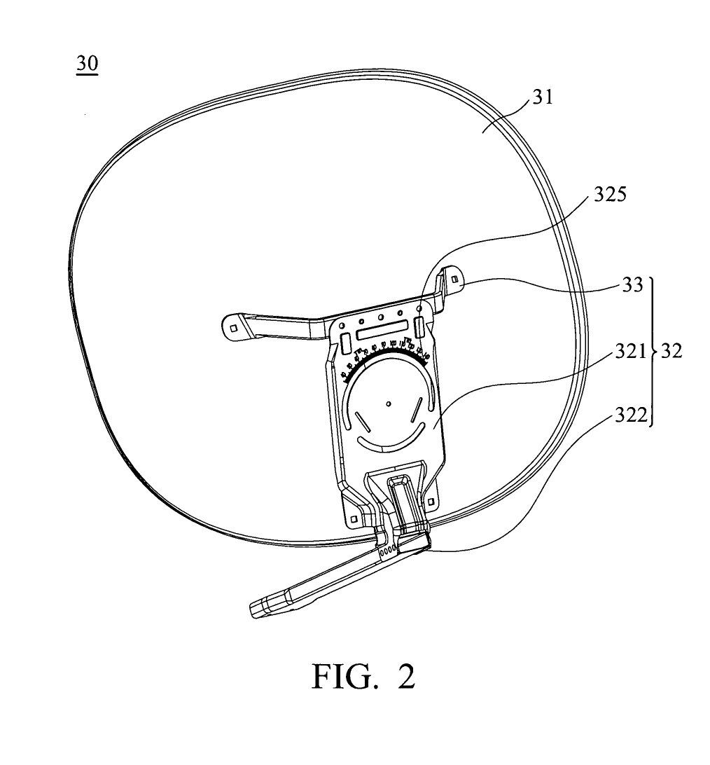

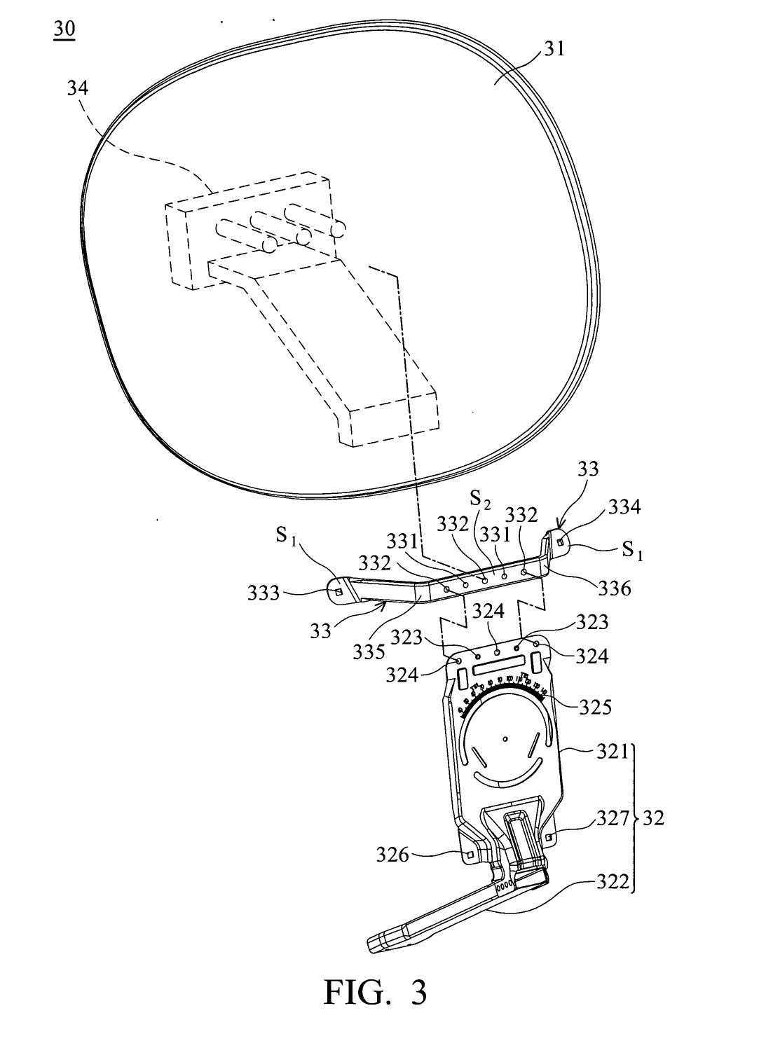

Referring to FIG. 2, the antenna set 30 comprises a dish 31, a supporting assembly 32, a connecting element 33 and a downconverter 34 (shown by FIG. 3). The downconverter 34 is installed on the supporting arm 322. The supporting assembly 32 comprises a dish bracket unit 321 and a supporting arm 322. One end of the dish bracket unit 321 connects to the supporting arm 322, and the other end connects to the connecting element 33. A plane that has the hole 325 is perpendicular to the horizontal plane. The connecting element 33 is fixed between the dish 31 and the dish bracket unit 32.

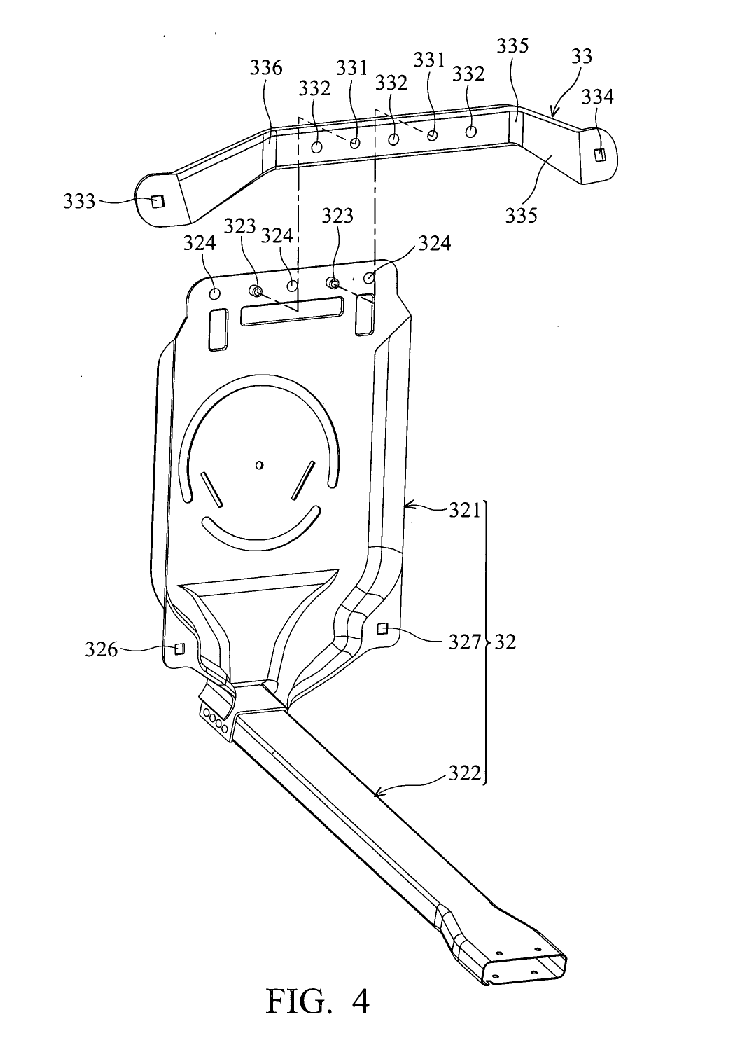

FIG. 3 is an exploded drawing of the antenna set 30. The connecting element 33 has a first connecting surface S₁ and the second connecting surface S₂, wherein, in the present embodiment, the connecting element 33 includes two third connecting portions 333 and 334 to define the first connecting surface S₁, and at lest one second connecting portion 331 is disposed on the connecting element 33 to define the second connecting surface S₂ of the connecting element 33. The two third connecting portions 333 and 334 of the first connecting surface S₁ is connected to the dish 31 via a plurality of screws (not shown), and the second connecting surface S₂ connects to the dish bracket unit 321. Two ends of the second connecting surface S₂ of the connecting element 33 respectively comprise a first bending portion 335 and a second bending portion 336, and the second connecting surface S₂ connects the third connecting portions 333 and 334 of the first connecting surface S₁ via the bending portions 335 and 336. The first connecting surface S₁ and the second connecting surface S₂ are separated by a distance. The dish bracket unit 321 comprises a plurality of first connecting portions 323, shown in FIG. 4. Referring to FIG. 4, the first connecting portions 323 are protrusions protruding toward the second connecting portions 331 of the connecting element 33. In this embodiment, the second connecting portions 331 are apertures. The apertures (the second connecting portions 331) fit the protrusions (first connecting portions 323). Thus, the connecting element 33 is connected to the dish bracket unit 321 via the second connecting portions 331 and the first connecting portions 323. The connecting element 33 and the dish bracket unit 321 respectively comprise a plurality of holes 332 and 324. The holes 332 correspond to the holes 324. A plurality of fixing element, for example screws (not shown), screw the holes 332 and 324 to connect to the connecting element 33 and the dish bracket unit 321. The dish bracket unit 321 further comprises two fourth connecting portions 326 and 327 fixed on the dish 31 to connect the dish 31 and the dish bracket unit 321 via a plurality of screws (not shown).

The invention provides a detachable antenna support structure. The single and unitary support structure of the invention does not require redesign when the size of the dish changes, thus, cost is reduced. The antenna set 30 of the invention comprises the dish bracket unit 321 to ensure range of rotation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A support structure of an antenna set, wherein the support structure supports a dish, comprising:
a supporting assembly, including a dish bracket unit and a supporting arm to connect to the dish bracket unit; and
a connecting element connected between the dish and the dish bracket unit, and including a first connecting surface and a second connecting surface;
wherein the first connecting surface is detachably connected to the dish; and
the second connecting surface is detachably connected to the dish bracket unit.

2. The support structure of an antenna set as claimed in claim 1, wherein the dish bracket unit comprises at least a first connecting portion; the second connecting surface comprises at least a second connecting portion; the first connecting surface comprises at least a third connecting portion; the first connecting portion is connected to the second connecting portion for fixing the connecting element on the dish bracket unit; and the third connecting portion is connected to the dish.

3. The support structure of an antenna set as claimed in claim 2, wherein the first connecting portion comprises a protrusion, and the second connecting portion comprises an aperture.

4. The support structure of an antenna set as claimed in claim 2, wherein the first connecting portion comprises an aperture, and the second connecting portion comprises a protrusion.

5. The support structure of an antenna as claimed in claim 1, wherein one end of the second connecting surface of the connecting element comprises at least a first bending portion; the other end of the second connecting surface of the connecting element comprises at least a second bending portion; the first and second bending portions are respectively connected to the first connecting surface; and a distance is between the first connecting surface and the second connecting surface.

6. The support structure of an antenna as claimed in claim 1, wherein the dish bracket unit forms a hole for the dish to rotate to form a tilt angle.

7. The support structure of an antenna set as claimed in claim 1, wherein the dish bracket unit comprises a fourth connecting portion to connect to the dish.

8. An antenna, comprising:
a dish;
a supporting assembly, comprising a dish bracket unit and a supporting arm to connect to the dish bracket unit;
a connecting element connected between the dish and the dish bracket unit, comprising a first connecting surface and a second connecting surface; and
a downconverter installed on the supporting arm;
wherein the first connecting surface and the second connecting surface are detachably connected to the dish; and
the second connecting surface is detachably connected to the dish bracket unit.

9. The antenna as claimed in claim 8, wherein the dish bracket unit comprises a dish bracket unit comprises at least a first connecting portion; the second connecting surface comprises at least a second connecting portion; the first connecting surface comprises at least a third connecting portion; the first connecting portion is connected to the second connecting portion for fixing the connecting element on the dish bracket unit; and the third connecting portion is connected to the dish.

10. The antenna as claimed in claim 9, wherein the first connecting portion comprises a protrusion, and the second connecting portion comprises an aperture.

11. The antenna as claimed in claim 9, wherein the first connecting portion comprises an aperture, and the second connecting portion comprises a protrusion.

12. The antenna as claimed in claim 8, wherein one end of the second connecting surface of the connecting element comprises at least a first bending portion; the other end of the second connecting surface of the connecting element comprises at least a second bending portion; the first and second bending portions are respectively connected to the first connecting surface; and a distance is between the first connecting surface and the second connecting surface.

13. The antenna as claimed in claim 8, wherein the dish bracket unit forms a hole for the dish to rotate to form the tilt angle.

14. The antenna as claimed in claim 8, wherein the dish bracket unit comprises a fourth connecting portion to connect to the dish.
